(19) United States
(12) Patent Application Publication
(10) Pub. No.: US 2011/0222854 A1
(43) Pub. Date: Sep. 15, 2011

(54) COHERENT OPTICAL HUBBING

(75) Inventors: Kim B. ROBERTS, Nepean (CA); James HARLEY, Nepean (CA)

(73) Assignee: CIENA CORPORATION, Linthicum (CA)

(21) Appl. No.: 13/047,356

(22) Filed: Mar. 14, 2011

Related U.S. Application Data
(60) Provisional application No. 61/313,330, filed on Mar. 12, 2010.

(51) Int. Cl. H04J 14/02

(52) U.S. Cl. 398/70

(57) ABSTRACT

An optical communications system includes a hub modem and a set of two or more remote modems. Each remote modem includes a transmitter stage for transmitting a respective uplink data stream within a selected one of a set of two or more sub-channels. The hub modem optically communicates with the set of remote modems. The hub modem includes a receiver stage having an optical front-end for receiving an uplink optical channel signal within a spectral range that encompasses the set of two or more spectral sub-bands; a photodetector for detecting modulation components of the received uplink optical channel signal and for generating a corresponding high bandwidth analog signal; and a digital signal processor for processing the high bandwidth analog signal to recover the respective uplink data stream transmitted by each remote modem.

### CROSS-REFERENCE TO RELATED APPLICATIONS

This application is based on, and claims benefit of, U.S. Provisional patent Application No. 61/313,330, filed Mar. 12, 2010, the entire contents of which are hereby incorporated herein by reference.

### MICROFICHE APPENDIX

Not Applicable.

### TECHNICAL FIELD

The present invention relates generally to optical communication systems, and in particular to coherent optical hubbing in an optical communication network.

### BACKGROUND

Referring to FIG. 1a, in an optical communications system, a transmitter 2 typically comprises a signal generator 4 for converting a digital signal X(n) to be transmitted into a drive signal SW which drives a modulator 6 (such as, for example, an Mach-Zehnder modulator (MZM) so as to modulate a narrow-band optical carrier, generated by a laser 8 tuned to a predetermined center wavelength λ1 to generate a corresponding optical channel signal, which may then multiplexed by a conventional MUX 10 into a WDM signal for transmission through an optical fiber link 12 to a receiver. Typically, the drive signal S(t) is a radio frequency (RF) analog electrical signal. In such cases, the signal generator 4 typically includes a digital signal processor (DSP) 14 cascaded with a digital-to-analog converter (DAC) 16. The DSP 14 operates to process the digital signal X(n) to generate a corresponding digital drive signal X′(m) which is designed in accordance with the performance and operating requirements of the DAC 16. The DAC 16 operates in a conventional manner to convert the digital drive signal X′(m) into the required analog RF drive signal S(t) for modulation onto the optical carrier.

As is known in the art, the optical channel signal can be demultiplexed and routed through the optical communications network using filter based DeMUX devices or Wavelength Selective Switches (WSSs) known in the art. FIG. 1b illustrates a typical receiver 18, which, for the sake of simplicity of illustration is coupled to a drop port of a WSS 20, which operates in a conventional manner to couple the channel signal from of an inbound WDM signal to the receiver 18. As may be seen in FIG. 1b, a typical receiver 18 comprises an optical front end for supplying the optical channel signal to a photodetector block 24, which operates in a conventional manner to detect the incoming optical channel signal and generate an electrical photodetector current which contains spectral components corresponding to the high-speed signal S(t). The photodetector current is then sampled by an Analog-to Digital Converter (ADC) 26 and processed by a DSP 28 using known digital signal processing techniques to recover the original digital signal X(n). In the receiver 18 of FIG. 1b, the optical front end 22 is provided by a mixer 30, which combines the incoming optical channel signal with a narrow-band light generated by a local laser 32 tuned to the center wavelength λ1 of the optical channel signal. As is well known in the art, this arrangement enables coherent detection of the optical channel signal. However, other arrangements, such as well known direct detection techniques are also commonly used.

It is known to have network topologies beyond simple point to point connections. Well known examples include Optical drop and continue, broadcast, rings, mesh, etc. In each of these topologies, a channel signal transmitted from a single modem (or, equivalently, electro-optical interface) is received by two or more remote modems at respective different sites. In many instances, each site is interested in only a portion of the content modulated on the channel signal. Typically, this requirement is addressed by means of a multiple access technology, in which a portion of the optical channel's information rate is allocated to each site.

Various multiple access techniques are known. For example, Time Division Multiple Access (TDMA), Code Division Multiple Access (CDMA), Orthogonal Frequency Division Multiple Access (OFDMA) are techniques that are commonly used in wireless communications to enable multiple remote terminals (in this case, wireless handsets) to transmit and receive signals that utilize an assigned portion of the bandwidth of a given communications channel. At least some of these techniques have been proposed for use in optical communications.

However, all of the techniques suffer a disadvantage in that the remote modem must be capable of transmitting and receiving the entire bandwidth of the communications channel. For example, in TDMA, during the modem's assigned timeslot(s), the modems must send and receive data at the full symbol rate of the communications channel. Similarly, CDMA requires the modem to transmit and receive a spread spectrum signal spanning the entire width of the communications channel, while using a code to identify the portion of the spectrum assigned to the remote modem. In order to maintain orthogonality, a remote receiver must sample its assigned OFDM signal at a sample rate sufficient to receive the entire channel signal. Similarly, a remote transmitter must generate its OFDM signal that is both coherent to and sampled at the same rate as the entire channel signal.

In all of these cases, the transmitters and receivers must be substantially symmetrical, in that (referring back to FIGS. 1a and 1b) the DACs 16 and ADCs 26 must be driven at about the same sample rate Fs, which must be selected based on the full symbol rate of the optical channel signal. At the low symbol (baud) rates of typical wireless channel signals (on the order of 20 KHz), the cost of suitable DACs and ADCs does not pose any great difficulty. However, optical communications networks commonly utilize channel symbol rates on the order of 20 GHz, and higher speeds are expected in the future. The cost of DACs and ADCs capable of supporting these baud rates makes it uneconomic to implement remote modems that will only utilize a portion of the bandwidth of the optical channel signal.

In many applications the full channel bandwidth represents more capacity than is needed. For example, an optical channel signal with a baud rate of 20 GHz can achieve a data rate of 100 Giga-bits/second (Gb/s). However, a central office serving a given town or neighbourhood may need only 40 Gb/s or less.

Techniques which overcome limitations of the prior art remain highly desirable.

### SUMMARY

An optical communications system includes a hub modem and a set of two or more remote modems. Each remote modem includes a transmitter stage for transmitting a respective uplink data stream within a selected one of a set of two or more sub-channels. The hub modem optically communicates with the set of remote modems. The hub modem includes a receiver stage having an optical front-end for receiving an uplink optical channel signal within a spectral range that encompasses the set of two or more spectral sub-bands; a photodetector for detecting modulation components of the received uplink optical channel signal and for generating a corresponding high bandwidth analog signal; and a digital signal processor for processing the high bandwidth analog signal to recover the respective uplink data stream transmitted by each remote modem.

### BRIEF DESCRIPTION OF THE DRAWINGS

Representative embodiments of the invention will now be described by way of example only with reference to the accompanying drawings, in which:

FIGS. 1a and 1b are block diagrams schematically illustrating elements of an optical communications system known in the art.

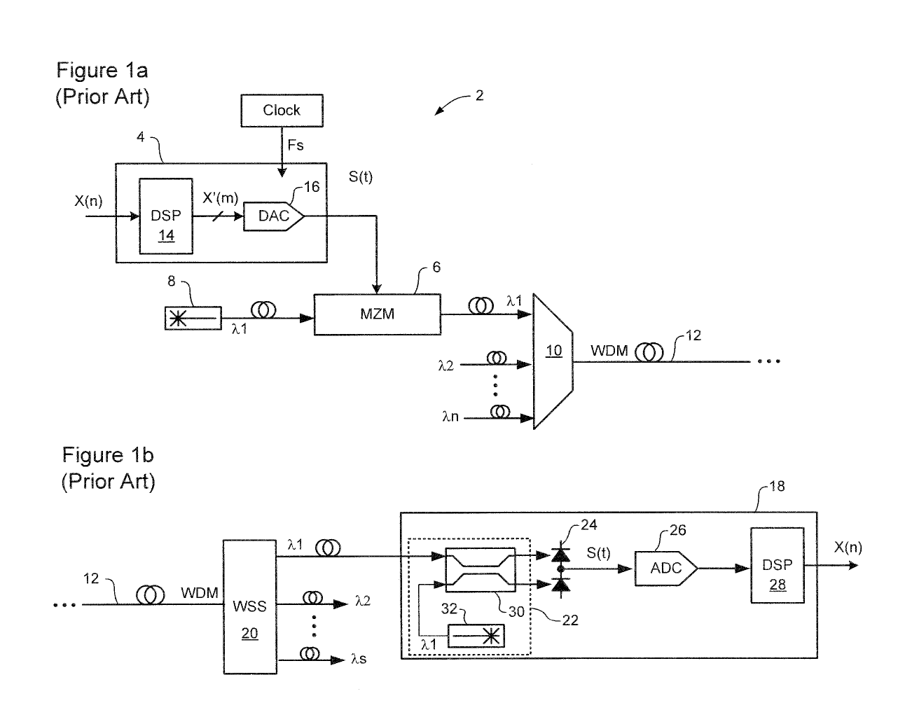

FIG. 2 is a block diagram schematically illustrating elements of a signal generator known from Applicant's copending U.S. patent application Ser. No. 12/692,065, filed Jan. 22, 2010;

FIG. 3 is a block diagram schematically illustrating elements of a signal generator usable in a hub modem in accordance with a representative embodiment of the present invention;

FIGS. 4a-4e are spectral diagrams illustrating operation of the signal generator of FIG. 3;

FIG. 5 is a block diagram schematically illustrating elements of receiver stage of a hub modem in accordance with a representative embodiment of the present invention;

FIG. 6 is a block diagram schematically illustrating a representative link of an optical network, utilizing optical hubbing in accordance with the present invention; and

FIG. 7 is a block diagram schematically illustrating elements of a remote modem in accordance with a representative embodiment of the present invention.

It will be noted that throughout the appended drawings, like features are identified by like reference numerals.

### DETAILED DESCRIPTION

In very general terms, the present invention provides a technique in which a single optical channel signal can be sub-divided into two or more sub-channels, each of which may be terminated at a respective independent remote modem. This enables the implementation of a hub-and spoke topology within a single optical channel of the network, while enabling the use of low cost components in each remote modem.

Applicant's copending U.S. patent application Ser. No. 12/692,065, filed Jan. 22, 2010, and entitled High Speed Signal Generator, teaches techniques for generating a high-bandwidth optical signal using multiple parallel lower speed Digital to Analog converters. The entire content of U.S. patent application Ser. No. 12/692,065 is incorporated herein by reference.

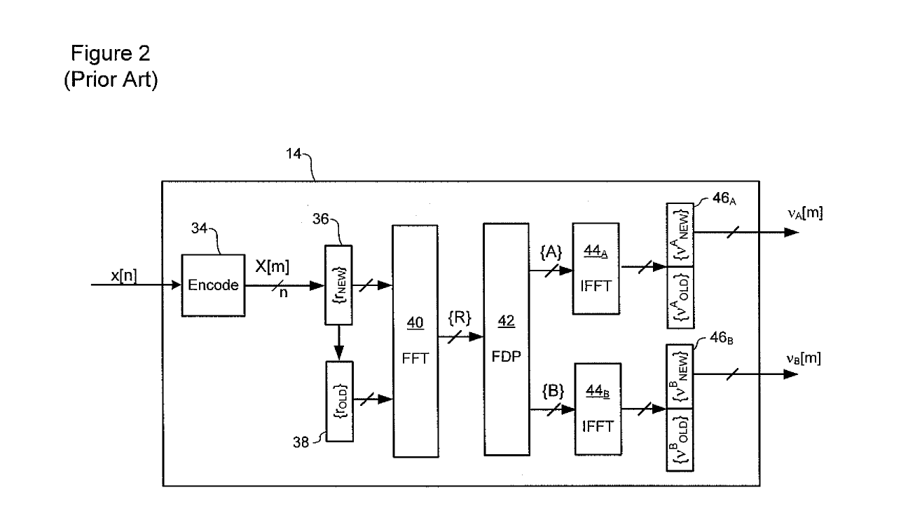

As described in U.S. patent application Ser. No. 12/692,065 the signal generator 4 of a transmitter 2 includes a DSP 14 that operates to process the input digital signal X(n) to generate a corresponding digital drive signal X′(m) in the form of a set of N parallel sub-band signals νₓ[m], which are subsequently processed to yield the desired high-speed analog signal S(t). FIG. 2 illustrates a DSP 14 known from U.S. patent application Ser. No. 12/692,065

As may be seen in FIG. 2, the DSP 14 comprises an encoding block 34 which receives and processes a subscriber data signal x[n] to generate a digital symbol stream X[m] to be transmitted. In some embodiments, the subscriber data signal x[n] may be a serial bit stream, but it could also be any type of digital signal such as, but not limited to a quantized signal. The encoding block 34 may implement any of a variety of algorithms including, but not limited to: encoding the subscriber data signal x[n] using a desired encoding scheme such as M-ary (Phase Shift Keying) PSK or Quadrature Amplitude Modulation (QAM); applying Forward Error Correction (FEC); and pre-distortion to compensate link impairments such as dispersion. In some embodiments, the symbols of the digital symbol stream X[m] may be complex valued symbols.

During each clock cycle, a set of M/2 successive symbols output from the encoder block 34 are deserialized (at 36) to generate a parallel input vector {r_{NEW}}. This input vector is combined with the input vector of the previous cycle {r_{OLD}} 38, and the resulting M-valued input array supplied to an FFT block 40, which computes an array {R} representing the spectrum of the M-valued input array. The FFT output array {R} is then supplied to a frequency-domain processor (FDP) 42, which implements a periodic convolution algorithm to generate corresponding sub-band arrays {A} and {B} containing the respective complex amplitudes of the spectral components for each digital sub-band signal. Each of the sub-band arrays {A} and {B} is processed using a respective IFFT block 44_{A}, 44_{B} to generate corresponding M-valued output vectors {v^{A}} and {v^{B}} 46_{A}, 46_{B}. The low-band output vector {v^{A}} can be divided into a pair of M/2-valued low sub-band vectors {v^{A}_{OLD}} and {v^{A}_{NEW}} respectively representing the sub-band signal ν_{A}[m] for the current and previous clock cycles. Similarly, the high-band output vector {v^{B}} can be divided into a pair of M/2-valued high sub-band vectors {v^{B}_{OLD}} and {v^{B}_{NEW}} respectively representing the sub-band signal ν_{B}[m] for the current and previous clock cycles. Accordingly, the respective sub-band signals ν_{A}[m] and ν_{B}[m] for the current clock cycle can be obtained by serializing the respective sub-band vectors {v^{A}_{NEW}} and {v^{B}_{NEW}}, and discarding the vectors {v^{A}_{OLD}} and {v^{B}_{OLD}} for the previous clock cycle.

If desired the resulting sub-band signals ν_{A}[m] and ν_{B}[m] can be retimed, for example by using a decimation function (not shown), to match the DAC symbol rate.

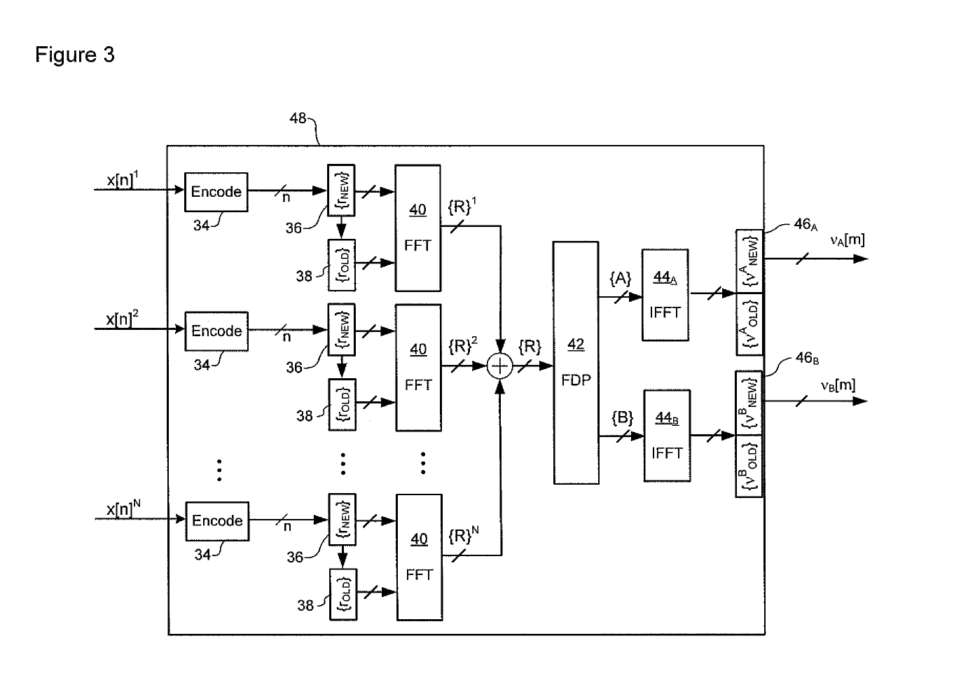

In accordance with the present invention, the flexibility of this signal generator is exploited to implement a hub modem designed to generate a optical channel signal which is subdivided into N≧2 sub-channel signals, each of which occupies a respective portion of the spectral range of the optical channel signal. FIG. 3 illustrates a signal generator 48 usable in an embodiment of the hub modem.

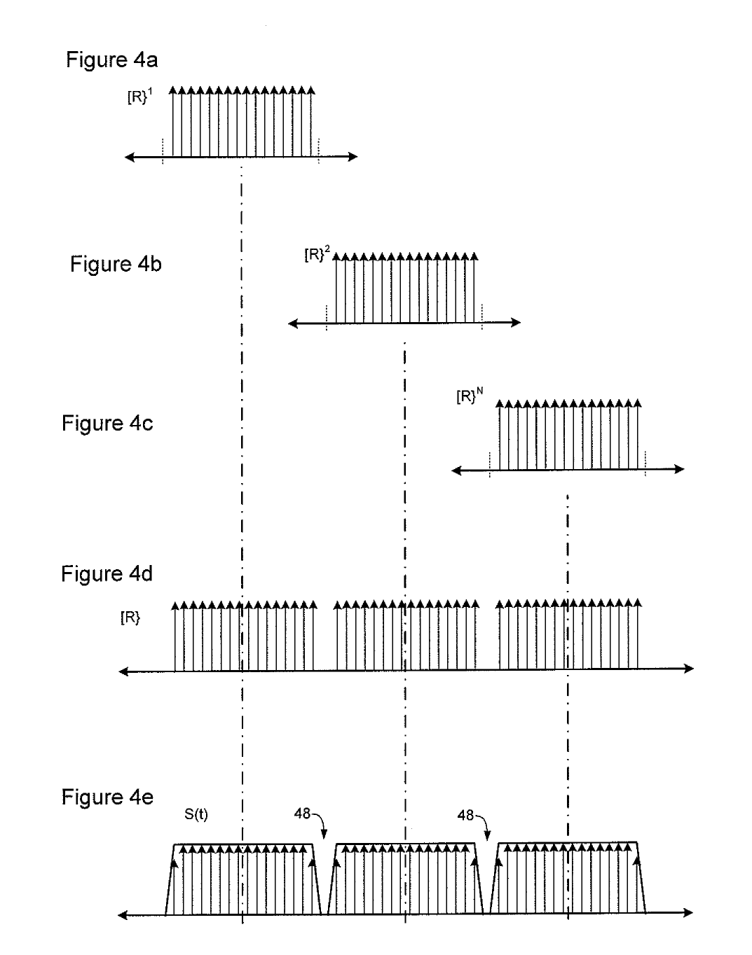

As maybe seen in FIG. 3, the signal generator 48 is similar to that of FIG. 2, except that the encoding block 34, deserializer 36,38 and FFT 40 are duplicated for each one of N sub-channel subscriber data signal x[n], each of which as a data rate equivalent to FIN, where F is the data rate of the full optical wavelength channel. Similarly, each sub-channel FFT block 40, computes an array {R}^{x} (x=1 . . . N) which represents the spectrum of its corresponding sub-channel signal, as may be seen in FIGS. 4a-4c. It is a simple matter to frequency shift and then combine the sub-channel arrays {R}^{x} to yield a channel array {R} (FIG. 4d) which represents the entire spectral width of the high speed signal S(t). The FDP 42 and IFFT blocks 44 can then operate in the manner described above, and in U.S. patent application Ser. No. 12/692,065 to obtain the sub-band signals ν_{A}[m] and ν_{B}[m] and thus the high speed output signal S(t) having a spectrum (FIG. 4e) in which each sub-channel occupies a respective spectral range.

As noted above, within the signal generator 48, each sub-channel data signal x[n] is processed by a respective encoder 34, which may implement any of a variety of algorithms including, but not limited to: encoding the subscriber data signal x[n] using a desired encoding scheme such as M-ary PSK or QAM; applying Forward Error Correction (FEC); and pre-distortion to compensate link impairments such as dispersion. In some embodiments, each encoder may implement the same algorithms, so that, for example, all of the sub-channel signals will be encoded with the same encoding scheme. However, this is not essential. In some embodiments, respective different encoding schemes may be used for different sub-channels. Furthermore, each of the sub-channels may have the same or different bandwidths. Similarly, some sub-channels may be compensated for more dispersion than others, and in fact some sub-channels may not be dispersion compensated at all. Thus, the specific encoding scheme and dispersion compensation implemented for each sub-channel may be selected based on the capabilities of each remote modem, and the respective distance between the hub modem and each remote modem.

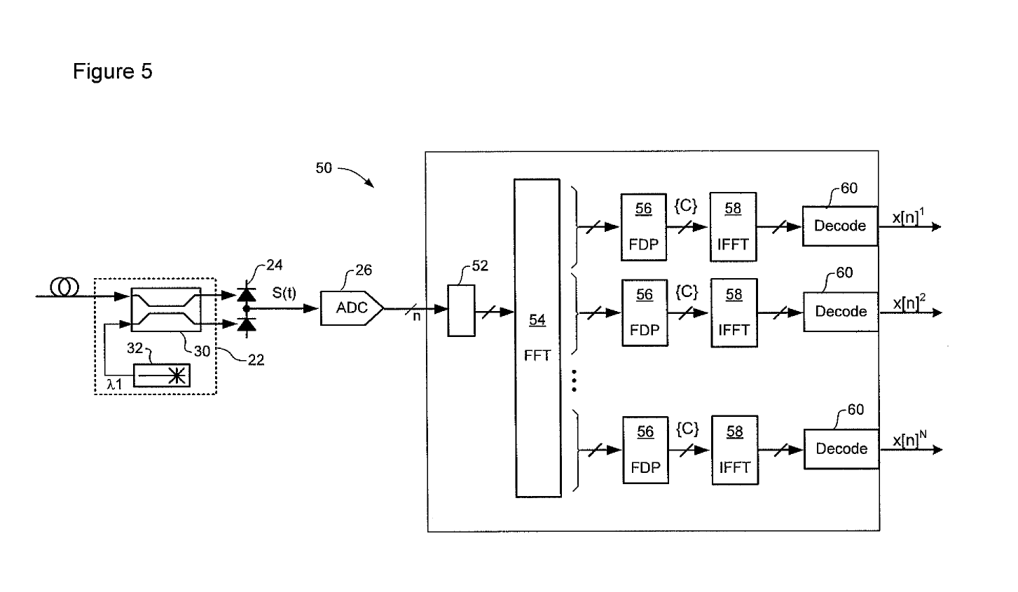

As may be appreciated, the receiver stage of the hub modem can be constructed to effectively mirror that of the transmitter stage. FIG. 5 illustrates a receiver stage 50 of a hub modem in accordance with a representative embodiment of the present invention. In the embodiment of FIG. 5, the photodetector current contains modulation components of the high-speed signal S(t) modulated on the received optical channel signal, and is sampled by and ADC 26 driven at a sample rate based on the full symbol rate of the optical channels signal. The resulting sample stream is deserialized at 52, to generate an input vector that is supplied to an FFT block 54. The output of the FFT block is an array that represents the spectrum of the high-speed signal S(t). As described above with reference to FIGS. 3 and 4, this spectrum is divided into sub-bands, each of which corresponds with a respective sub-channel signal. Accordingly, the FFT output array can be divided into appropriate sub-arrays, each or which is supplied dot a frequency domain processor FDP 56, which applies dispersion compensation in a manner known in the art to generate a compensated Array {C}. The compensation array can then be supplied to a IFFT block 58, which outputs a compensated sub-channel sample stream that is supplied to a respective decoder 60 for carrier recovery, symbol detection and decoding in a known manner to recover the respective sub-channel data signal x[n].

As noted above, in the embodiment of FIG. 5, the ADC 26 is driven to sample the photodetector current at a sample rate that is based on the full symbol rate of the optical channel signal. In alternative embodiments, the techniques of U.S. patent application Ser. No. 12/692,065 may be used to divide the photodetector current into sub-bands, which are then sampled by parallel lower rate ADCs to yield a set of sub-band signals νₓ[m], which may or may not correspond with the sub-channels. In this case, the serializer 52 and FFT 54 of FIG. 5 would be replicated for each sub-band signal νₓ[m], and then the output arrays of the FFTs combined using a frequency domain processor designed to invert the periodic convolution function described above with reference to FIG. 2. This operation yields a combined array that represents the full spectrum of the received optical channel signal, formatted in a manner that enable separation and recovery of each sub-channel signal, as described above.

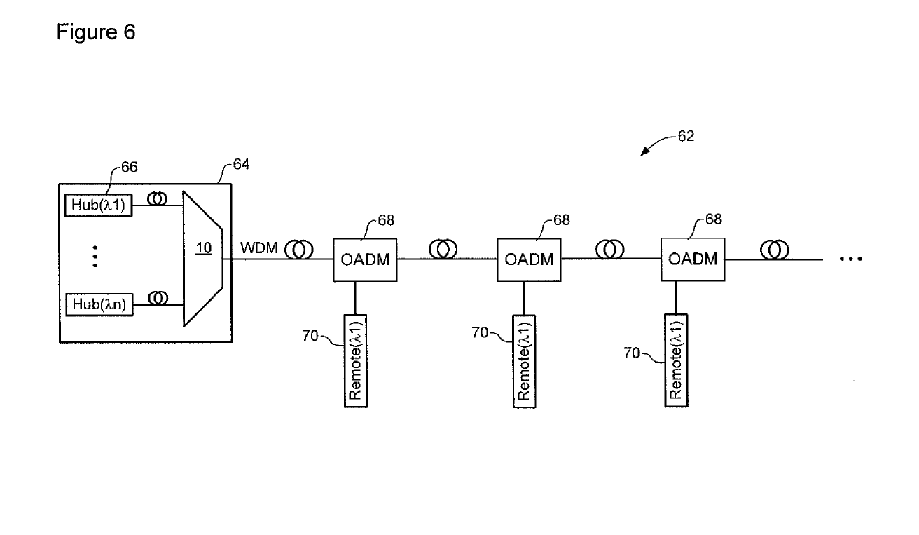

The hub modem described above is capable of transmitting and receiving an optical channel signal that contains two or more sub-channels, which are independently encoded and occupy a respective sub-range of the full spectrum of the optical channel signal. Since the sub-channels all lie within the spectral range of the optical channel signal, the optical communications network will route all of the sub-channels together through the network. per-sub-channel routing, by definition, is not possible. By using known wavelength switching, drop and continue, and power splitting techniques, the network can operate to route the optical channel signal to each one of a set of remote modems, each of which is designed to terminate a respective one of the sub-channels. Thus, FIG. 6 illustrates a possible optical communications network 62, in which a network node 64 comprises a plurality of hub modems 66, each of which is configured to send and receive respective optical channel signals within a predetermined channel plan of the network. A conventional MUX 10 couples respective channel signals between each hub modem 66 and an optical fiber link, which comprises a plurality of OADMs 68. Each OADM 68 implements a Drop-and-Continue ADM architecture in a known manner so that, for example, the optical channel signal centered on carrier λ1 can be routed to a plurality of remote modems 70, each of which is tuned to a respective sub-channel.

Preferably, each remote modem 70 is configured to send and receive data signal traffic within a respective one of the sub-channels of the optical channel signal. Thus, in an embodiment in which the optical channel signal (or, equivalently, the high speed analog signal S(t)) has a total capacity of 100 Gb/sec, and comprises five sub-channels of 20 Gb/sec, a total of five remote modems 70 may provided, each of which is configured to transmit and receive optical signals within at a line speed 20 Gb/sec.

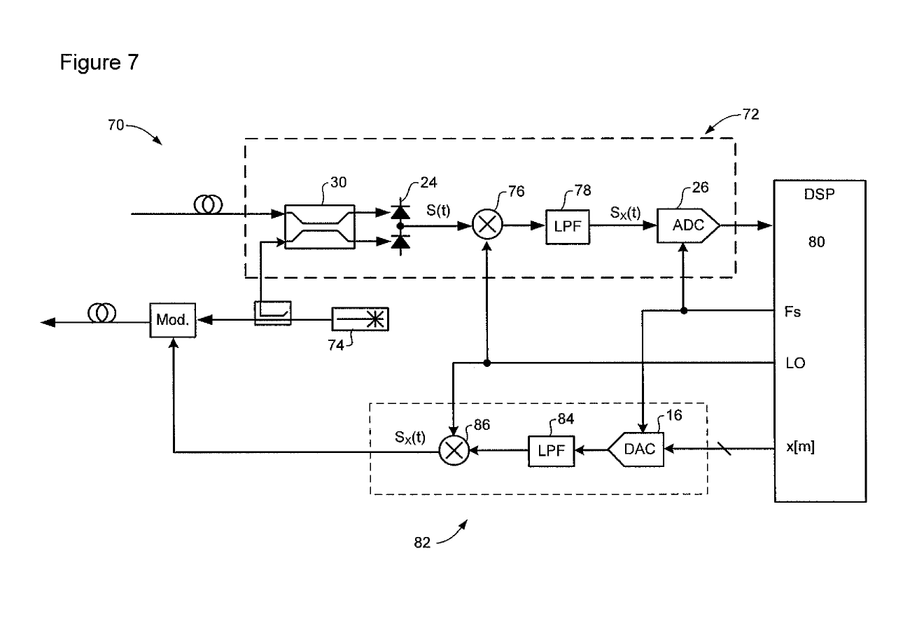

In some embodiments, each remote modem 70 may use known coherent receiver techniques to detect and receive the desired sub-channel, while having sufficient Common Mode Rejection Ratio (CMRR) to avoid interference from the adjacent sub-channels. For example, FIG. 7 illustrates an embodiment in which a coherent detection receiver stage 72 includes a mixer 30 for mixing an incoming optical channel signal with a narrow-band light generated by a local laser 74 tuned to the center wavelength λ1 of the optical channel signal, and a photodetector 24 for receiving the composite light output from the optical mixer 30. As is known in the art, this arrangement is suitable for coherent detection of the incoming optical channel signal, so that the photodetector current contains spectral components corresponding to the high-speed signal S(t). An electronic RF mixer 76 cascaded with a low-pass filter 78 can then be used in a conventional manner to extract the desired sub-channel from the high-speed signal S(t). The isolated sub-channel signal can then be sampled by an ADC 26 which can be driven at a sample rate Fs determined by the symbol (baud) rate of the sub-channel, rather than the whole optical channel signal. A DSP 80 can then implement known digital signal processing techniques to recover the respective downlink signal modulated on the received sub-channel.

As may be seen in FIG. 7, the transmitter section 82 of the remote modem 70 may include a DAC 16, which is also driven at a sample rate Fs determined by the symbol (baud) rate of the sub-channel, to convert an uplink symbol stream into a corresponding analog sub-channel signal for transmission to the hub-modem. The analog sub-channel signal can then be filtered at 84 to remove out-of band noise, and mixed (at 86) with a local oscillator signal LO tuned to the appropriate frequency offset (relative to the center frequency of the optical channel signal) for the sub-channel assigned to that specific remote modem 70. The resulting analog sub-channel signal Sx(t) can be modulated onto an optical carrier (again, tuned to match that of the optical channel signal, to yield an optical sub-channel signal that can be propagated through the network to the hub modem.

As may be appreciated, each remote modem that communicates with a hub modem using via a given optical channel signal, will transmit a respective optical sub-channel signal that occupies a limited (and substantially non-overlapping) portion of the entire spectrum of the optical channel signal. As the multiple optical sub-channel signals propagate towards the hub modem, the network routing equipment will inherently combine the sub-channel signals together, so that the hub modem receives the entire optical channel signal.

In the embodiment of FIG. 7, a common local laser 74 is used for both receiving the inbound wavelength channel, and for generating the optical sub-channel signal being transmitted to the hub modem. Similarly, the same sample clock is used to drive both the ADC 26 and the DAC 16; and the same Local oscillator is used in both the receiver and transmitter sections 72 and 82. This is possible because both the receiver and transmitting stages are tuned to the same sub-channel of the same optical channel signal, and offers an advantage in that it helps limit the number of components (and thus the cost) of the remote modem. A significant advantage of this arrangement is that the optical frequency of the laser 74 in the remote modem can then be locked by the coherent receiver control to the desired frequency relative to the optical channel carrier (and thus the hub laser 8). With each of the remote modem lasers 74 so locked, the uplink sub-channel signals can be optically added together without the need for large guard-bands 48 separating them being required in order to prevent cross-talk due to laser frequency drift or uncertainty. However, these arrangements are not essential; alternative modem designs will be apparent to those of ordinary skill in the art, and may be used without departing from the intended scope of the present invention.

The use of a hub modem with multiple remote modems achieves economy of scale in the hub modem to get lowest cost per bit at the hub, and lowest cost per site at the remote sites by minimizing the bandwidth of the remote modems.

In some embodiments, each remote modem may utilize a directly modulated laser, or an integrated laser-modulator to transmit an optical signal within the modem's designated sub-band. In such cases, the receiver of the hub modem is preferably configured as a coherent receiver capable of compensating at least dispersion of the received sub-band. As may be appreciated, one consequence of terminating each sub-band at a respective different remote modem is that, at the hub modem, each sub-band of the incoming wavelength channel may be subject to a respective different amount of dispersion. This can be overcome by configuring the hub modem to apply a respective different amount of dispersion compensation on each sub-band. Such a receiver may also be configured to compensate impairments due to low-cost optical elements of the remote modem. An advantage of this arrangement is that it enables the transmitter stage of the remote modem to be constructed using low-cost and low power consumption components.

Alternatively, the remote mode could use the same silicon as the hub modem but low bandwidth coherent electro-optics. In this arrangement, the DSP of the remote modem has the same dispersion compensation capabilities as the hub modem, and so is capable of both compensating dispersion in a received signal, as well as pre-compensating uplink signals prior to transmission to the hub modem. This arrangement achieves economies of scale in terms of utilizing the same electronic components in both the hub and remote modems. Additional cost savings are obtained in the remote modems by way of the use of lower-cost optical components, which can be used in the remote modem in view of its lower bandwidth requirements.

In the embodiments described above fractional access is provided using a Frequency Division Multiple Access scheme, in which each remote modem is tuned to a respective sub-band. Alternative methods of fractional access such as time division access, or code division access, can be used where the bandwidths required in the remote modem can be achieved cost effectively.

Although the invention has been described with reference to certain specific embodiments, various modifications thereof will be apparent to those skilled in the art without departing from the spirit and scope of the invention as outlined in the claims appended hereto.

We claim:

1. An optical communications system comprising:
a set of two or more remote modems, each remote modem including a transmitter stage for transmitting a respective uplink data stream within a selected one of a set of two or more spectral sub-bands; and
a hub modem optically communicating with the set of remote modems, the hub modem including a receiver stage comprising:
an optical front-end for receiving an uplink optical channel signal within a spectral range that encompasses the set of two or more spectral sub-bands;
a photodetector for detecting modulation components of the received uplink optical channel signal and for generating a corresponding high bandwidth analog signal; and
a digital signal processor for processing the high bandwidth analog signal to recover the respective uplink data stream transmitted by each remote modem.

2. The optical communications system as claimed in claim 1, wherein the optical front-end comprises a coherent receiver tuned to receive the uplink optical channel signal.

3. The optical communications system as claimed in claim 1, wherein the optical front-end comprises a DEMUX filter for separating the uplink optical channel signal from a set of two or more Wavelength Division Multiplexed (WDM) optical channel signals.

4. The optical communications system as claimed in claim 1, wherein a sub-band has a spectral width of F₁.

5. The optical communications system as claimed in claim 4, wherein each up-link data stream has a baud-rate of F₁/2

6. The optical communications system as claimed in claim 4, wherein the uplink optical channel signal has a spectral width approximately equal to the sum of the F₁ for each sub-band.

7. The optical communications system as claimed in claim 1, wherein an encoding scheme used by a selected one remote modem is the same as that used by another remote modem.

8. The optical communications system as claimed in claim 1, wherein an encoding scheme or a bandwidth used by a selected one remote modem is different from that used by another remote modem.

9. The optical communications system as claimed in claim 1, wherein the digital signal processor is configured to compensate a respective different dispersion of each sub-band.

10. The optical communications system as claimed in claim 1, wherein the digital signal processor is configured to compensate a respective different polarization impairment of each sub-band.

11. The optical communications system as claimed in claim 1, wherein:
the hub modem further includes a transmitter stage for transmitting a respective downlink data stream to each remote modem, the transmitter stage comprising:
a signal processor for processing the downlink data streams to derive a high bandwidth analog signal;
an optical modulator for modulating a narrow-band optical carrier light in accordance with the high bandwidth analog signal to generate a downlink optical channel signal having a spectral range that encompasses the set of two or more spectral sub-bands;
wherein modulation components of the optical channel signal corresponding to the respective downlink data stream destined to any given remote modem are contained within the spectral sub-band of that remote modem; and
each remote modem comprises a receiver for receiving the modulation components of the optical channel signal within its respective spectral sub-band.

12. The optical communications system as claimed in claim 11, wherein the transmitter stage of each remote modem is frequency locked to the narrow-band optical carrier light of the downlink optical channel signal.

13. The optical communications system as claimed in claim 11, wherein the receiver stage of at least one remote modem is a coherent receiver.

14. The optical communications system as claimed in claim 11, wherein the signal processor is configured to compensate a respective different dispersion of each sub-band.

15. The optical communications system as claimed in claim 14, wherein the receiver stage of at least one remote modem is a direct detection receiver.

16. A modem comprising:
a transmitter section configured to generate a high speed analog signal having a predetermined bandwidth and comprising a plurality of sub-channels, each sub-channel comprising spectral components of a respective data signal; and
a receiver section configured to receive a high speed analog signal having a predetermined bandwidth and comprising a plurality of sub-channels, each sub-channel comprising spectral components of a respective data signal, the receiver stage comprising a receiver digital signal processor for recovering the respective data signal of each sub-channel.

17. The modem as claimed in claim 16, wherein the transmitter section comprises a transmitter digital signal processor for predistorting the high speed analog signal to compensate dispersion.

18. The modem as claimed in claim 17, wherein the transmitter digital signal processor is configured to predistort each sub-channel independently, so as to compensate a respective different amount of dispersion in each sub-channel

19. The modem as claimed in claim 16, wherein the receiver section digital signal processor is configured to compensate dispersion in the received high speed analog.

20. The modem as claimed in claim 19, wherein the receiver section digital signal processor is configured to compensate a respective different amount of dispersion in each sub-channel.
